(19) United States
(12) Patent Application Publication
(10) Pub. No.: US 2005/0193891 A1
(43) Pub. Date: Sep. 8, 2005

(54) Espresso making apparatus and method of brewing espresso

(76) Inventors: Brent Garson, Solon, OH (US); Aviel Dafna, Modiin (IL); Fabrizio Pin, Treviso (IT)

Correspondence Address: Marvin L. Union, 13530 Heath Road, Novelty, OH, 44072, US

(21) Appl. No.: 10/796,368

(22) Filed: Mar. 8, 2004

(51) Int. Cl. A23F 3/00

(52) U.S. Cl. 99/279

(57) ABSTRACT

A new and improved espresso making apparatus and method of making espresso is disclosed in which a motor is utilized to move a piston to compress ground coffee in a pressure chamber a predetermined amount and wherein the amount of compression of the ground coffee is controlled by sensing a motor parameter such as voltage or current which is related to the amount of compression of the ground coffee in the pressure chamber. The motor rotates a cam and the piston is operatively connected to a cam follower which engages the cam and moves the piston in response to rotation of the motor to compress the ground coffee in the pressure chamber until the sensed rotor parameter exceeds a preset reference.

### BACKGROUND OF THE INVENTION

### RELATED APPLICATIONS

NONE

### FIELD OF THE INVENTION

The present invention relates to an espresso making apparatus and a method for brewing espresso and more particularly to a mechanism for compacting a predetermined variable amount of ground coffee in a pressure chamber to facilitate the brewing of various sizes of espresso based beverages.

Espresso makers are known in the art and espresso makers for automatically brewing espresso are well known. Known prior art espresso makers for automatically brewing espresso are actuated by the user actuating a selector switch and a credit entering mechanism such as a coin receiver. The known automatic espresso makers utilize a piston which compresses ground coffee within a pressure chamber to compact the ground coffee a predetermined amount prior to passing pressurized hot water through the ground coffee to brew espresso. Known espresso making apparatus utilize a linkage to move the piston and piston rod in a reciprocating fashion within the pressure chamber as is illustrated in FIG. 10. The linkage moves the piston in a fashion similar to the movement of a piston within a cylinder of an internal combustion engine to reduce the volume of the pressure chamber to a minimum predetermined volume (when the piston is fully extended into the pressure chamber as is illustrated in FIG. 10(a)) and compact any ground coffee in the pressure chamber to the minimum volume. When espresso is to be brewed pressurized hot water is injected into the pressure chamber and it is desired to have the piston rod and linkage in line (see FIG. 10(a)) to prevent movement of the piston to increase the volume of the pressure chamber when pressurized hot water is directed into the piston chamber. Aligning the piston rod and linkage, as is illustrated in FIG. 10(a), allows the piston to resist the high pressure force of the pressurized hot water in the pressure chamber. If the linkage and piston rod are not in line (see FIG. 10(b)), the pressure of the pressurized water can push the piston and linkage to cause undesirable expansion of the pressure chamber when the espresso is being brewed as a result of the pressurized water being injected therein.

The use of a linkage and piston fixes the minimum volume of the pressure chamber to a fixed minimum volume when the piston and linkage are in line. Since the piston and linkage must be aligned to resist the force of the pressurized water, the piston and linkage must be moved to the same position each time to compact the coffee grounds in the pressure chamber. If different amounts of coffee grounds are present, the coffee grounds will be compacted to different degrees due to the fact that the volume of the pressure chamber will be reduced to a fixed minimum volume by movement of the piston irrespective of the volume of coffee grounds located in the pressure chamber, i.e., if an excessive amount of ground coffee is placed in the pressure chamber, the ground coffee will be compacted to a higher degree than if less coffee were placed in the pressure chamber. This results in a prior art machine which is capable of only brewing one size of espresso drink because the volume of the pressure chamber is constant and cannot be varied without varying the degree of compactness of the ground coffee. Also, in the prior art machines, the amount of coffee placed in the pressure chamber must be carefully controlled to maintain the correct amount of compaction of the ground coffee.

Accordingly, it is an object of the present invention to provide a new and improved espresso making apparatus and a method for brewing espresso which enable espresso drinks of various size to be automatically brewed from the same machine while maintaining a substantially uniform compactness of the ground coffee through which the pressurized hot water is passed to brew an espresso beverage.

### BRIEF SUMMARY OF THE INVENTION

The present invention provides a new and improved espresso making apparatus which includes a supply of pressurized hot water, a pressure chamber for receiving a predetermined amount of ground coffee therein, a piston movable within the pressure chamber to compact the ground coffee, a cam, a motor for rotating the cam, a cam follower operatively associated with the piston for moving the piston in response to rotation of the cam, a sensor for sensing a parameter of the motor, a control for deenergizing the motor when the ground coffee in the pressure chamber is compressed a predetermined amount and the sensed motor parameter is equal to a predetermined value, a fluid passageway for directing the supply of pressurized hot water through the compressed ground coffee in the pressure chamber to brew espresso and an outlet from the pressure chamber for directing the brewed espresso to a use location.

Still another provision of the present invention is to provide a new and improved espresso making apparatus including a supply of pressurized water, a pressure chamber for receiving a predetermined amount of ground coffee, a piston movable within the pressure chamber to compress the ground coffee, a motor for moving the piston, a sensor for sensing a parameter of the motor when the motor moves the piston, a control for denergizing the motor to stop movement of the piston when the ground coffee in the pressure chamber is compressed a predetermined amount and the sensed motor parameter is equal to a predetermined value, a fluid passageway for directing the supply of hot water through the compressed coffee in the pressure chamber to brew espresso and an outlet from the pressure chamber for directing the brewed espresso to a use location.

A further provision of the present invention is to provide a new and improved method of brewing espresso from a supply of pressurized hot water and ground coffee which has been compacted a predetermined amount by a motor which moves a piston to compact the ground coffee in a pressure chamber including the steps of providing a predetermined amount of ground coffee in the pressure chamber, energizing the motor, moving the piston within the pressure chamber to compact the ground coffee in response to energization of the motor, sensing a motor parameter of the motor while the motor moves the piston to compact the ground coffee in the pressure chamber and deenergizing the motor to stop movement of the piston when the sensed motor parameter is equal to a predetermined value and the ground coffee is compacted a predetermined amount in the pressure chamber.

The various features of novelty which characterize the invention are pointed out with particularity in the claims annexed to and forming a part of the disclosure. For a better understanding of the invention, its operating advantages and specific objects obtained by its use, reference is made to the accompanying examples, drawings and descriptive matter in which a preferred embodiment of the invention is illustrated.

### BRIEF DESCRIPTION OF THE DRAWINGS

FIG. 1 is a schematic representation of an espresso maker constructed in accordance with the present invention.

FIG. 2 is a fragmentary view of a portion of the espresso maker of FIG. 1 illustrating the grinding of the coffee beans and the movement of the ground coffee into the pressure chamber.

FIG. 3 is a fragmentary view similar to FIG. 2 illustrating the initial rotation of the cam and initial movement of the piston toward the pressure chamber to compact the ground coffee.

FIG. 4 is a fragmentary view similar to FIG. 3 illustrating the cam rotated to a position in which the coffee in the pressure chamber is compressed a predetermined amount and wherein pressurized hot water is injected into the pressure chamber through the compressed coffee to brew espresso.

FIG. 5 is a fragmentary view illustrating movement of the latch to its unlatched position to enable the lower piston to be moved to open the bottom of the pressure chamber.

FIG. 6 is a fragmentary view illustrating movement of the lower piston to open the bottom of the pressure chamber.

FIG. 7 illustrates further rotation of the cam and piston and expulsion of the ground coffee from which espresso has been brewed from the pressure chamber.

FIG. 8 illustrates further rotation of the cam to return the cam to its initial standby position, closing of the bottom of the pressure chamber by the lower piston and movement of the upper piston to its initial standby position.

FIG. 9 is a schematic illustration of the control for the motor.

FIG. 10 is a schematic illustration of a prior art espresso maker which utilizes a piston and linkage assembly to compress the ground coffee where FIG. 10(a) illustrates the piston rod and linkage in an in line position and FIG. 10(b) illustrates the piston rod and linkage in a not in line position.

### DETAILED DESCRIPTION OF THE INVENTION

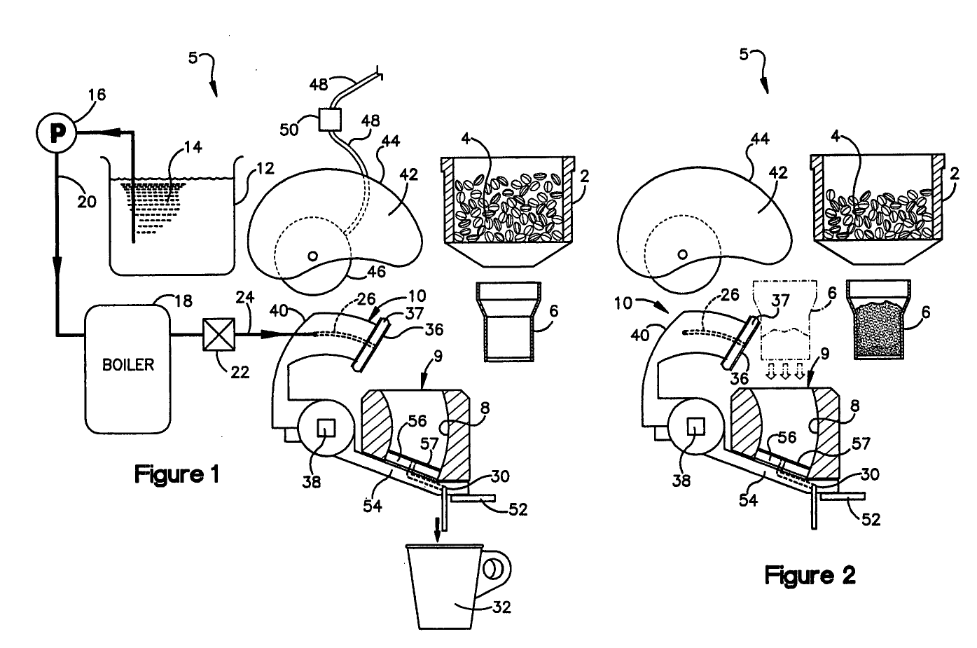

Referring to the figures and more particularly to FIG. 1 an espresso making apparatus 5 is disclosed. The espresso maker 5 includes a coffee hopper 2 having coffee beans 4 stored therein and a coffee grinder 6 which is adapted to receive coffee beans from the coffee hopper 2, grind the beans and deliver the ground coffee to a use location.

A pressure or brewing chamber 8 is located within the espresso making apparatus 5. The pressure chamber 8 includes a first or top opening 9 and a second or bottom opening 11, and is operable to receive the ground coffee therein as is more fully illustrated in FIG. 2 wherein the coffee grinding mechanism 6 is moved to a position contiguous to the top opening 9 of the pressure chamber 8 to drop a predetermined amount of ground coffee therein. The amount of ground coffee deposited into the pressure chamber 8 is dependent upon the time period that the coffee grinder 6 is energized and the particular espresso drink to be brewed. After a predetermined amount of ground coffee is located within the pressure chamber 8, the pressure chamber 8 is closed by a piston 10 which compresses the ground coffee disposed within the pressure chamber 8 prior to hot water being passed through the compacted ground coffee in the pressure chamber 8 to brew espresso.

A water supply in the form of a water tank 12 is provided having a supply of water 14 for brewing espresso disposed therein. A pump 16 is adapted to pump water 14 from the supply 12 to a water heater or boiler 18 via fluid conduit 20. The boiler 18 heats the water 14 which is directed through a valve 22 to fluid conduit 24. Fluid conduit 24 is connected to the piston 10 which includes a fluid passageway 26 disposed therein. When the ground coffee in pressure chamber 8 is compacted a predetermined amount by piston 10, pump 16 is energized to pump pressurized water to boiler 18, boiler 18 heats the water and valve 22 is opened to provide for the passage of pressurized hot water from boiler 18 through fluid conduit 24 and passageway 26 and into the compacted coffee disposed within the pressure chamber 8. A passageway 30 is provided from pressure chamber 8 to direct the brewed espresso to a use location such as a container or cup 32. After the ground coffee in pressure chamber 8 is compacted a predetermined amount of pressurized hot water is directed through the fluid passageway 26 in piston 10 and through the compacted ground coffee in pressure chamber 8 to brew espresso which is then delivered through the passageway 30 to the cup 32.

The piston 10 includes a piston head 36 which is adapted to be received in the pressure chamber 8 to compress ground coffee disposed in the pressure chamber 8. An O-ring seal 37 is located on piston head 36 to establish a seal between the piston head 36 and pressure chamber 8. The piston 10 is supported on and is pivotable about shaft 38 and include a cam follower 40. A rotatable cam 42 is supported adjacent piston 10 and includes a cam surface 44 which is operable to engage with the cam follower 40 operatively associated with the piston 10 upon rotation of cam member 42. While the cam follower 40 is disclosed as a portion of piston 10, it should be apparent that the cam follower 40 may be a separate member which is operatively connected to piston 40 rather than integral therewith, as is illustrated, without departing from the scope of the present invention. A motor 46 is provided for effecting rotation of cam member 42. Conductors 48 are provided to connect the motor 40 to a source of power in a well known manner. A control 50 is associated with conductors 48 to sense a motor parameter of motor 46 which is used to control energization of the motor 46. Example of motor parameters which could be sensed include current, voltage and/or torque.

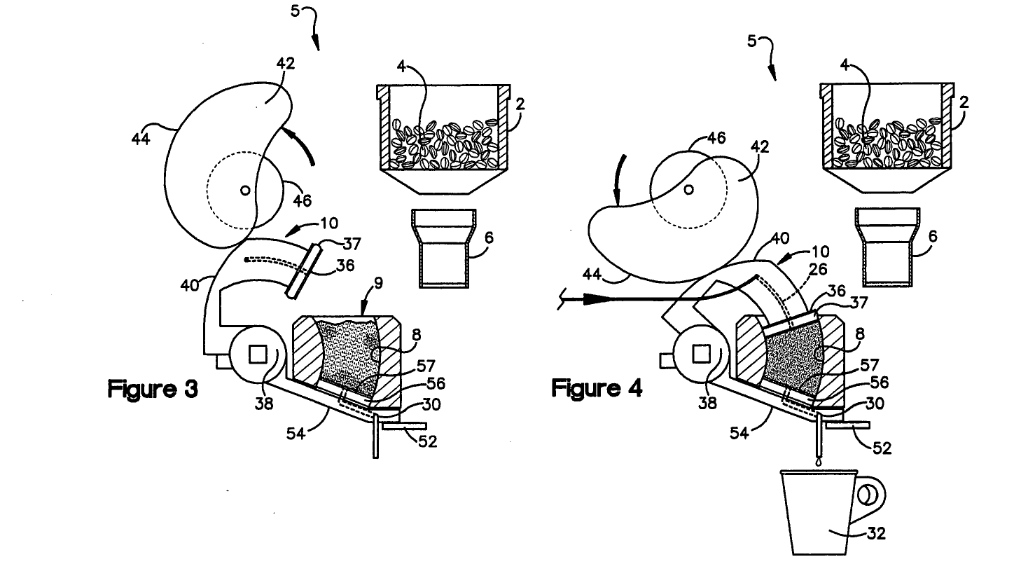

When it is desired to brew espresso, a predetermined amount of ground coffee is deposited into the coffee grinder 6 which grinds the coffee and deposits the ground coffee into the pressure chamber 8, as is illustrated in FIGS. 2 and 3. After the ground coffee is located in the pressure chamber 8 and the coffee grinder 6 is retracted to its full line position illustrated in FIG. 3, motor 46 is energized to rotate cam member 42. As cam member 42 rotates, cam surface 44 engages with the cam follower 40 on piston 10 and effects pivotable movement of the piston 10 about shaft 38 in a clockwise direction as is viewed in FIG. 3. Continued energization of motor 46 causes the cam member 42 to continue to rotate until the ground coffee in pressure chamber 8 is compressed a predetermined amount as is illustrated in FIG. 4. The resistance of piston 10 to further compressive movement by rotation of cam member 42 increases as the ground coffee in pressure chamber 8 is compressed. The increased resistance to motor movement is reflected in a change in a motor parameter associated with the motor 46 which is sensed by the control 50.

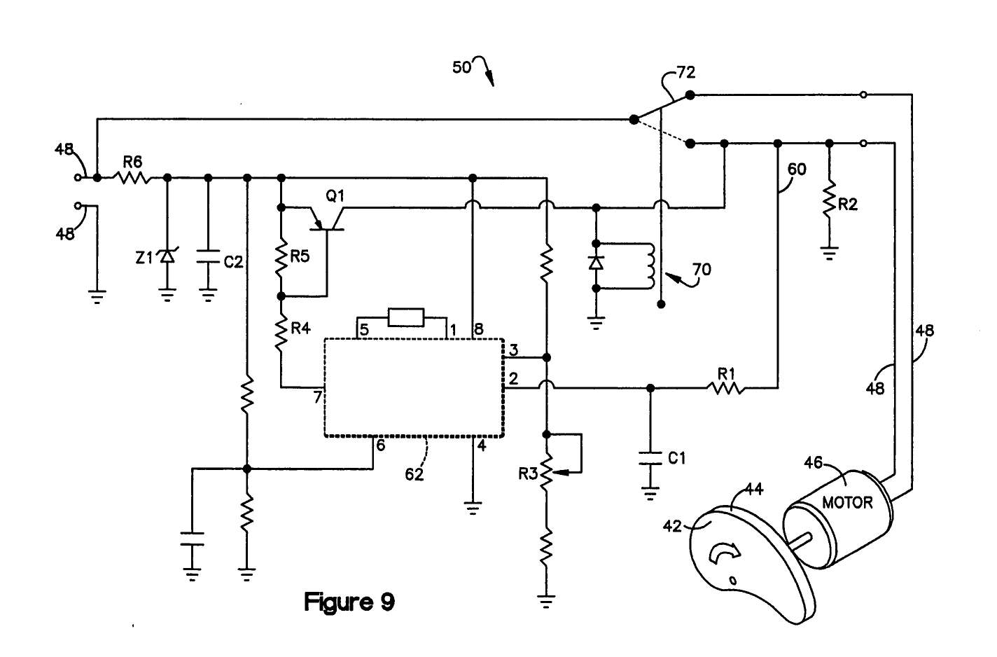

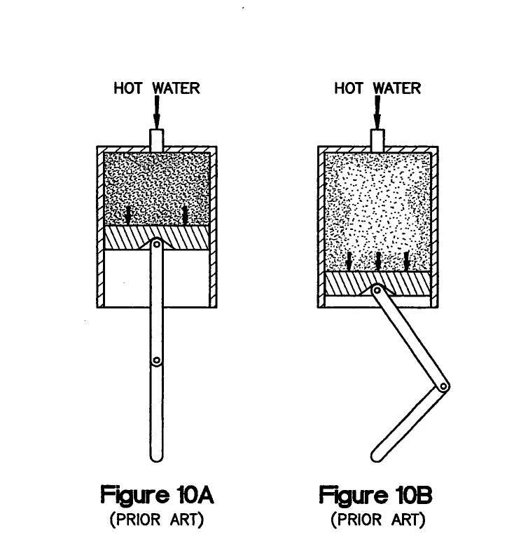

In one embodiment of the invention as is disclosed in FIG. 9, control 50 senses the motor current of motor 46 as motor rotates cam 42 and piston 10 compresses the ground coffee in pressure chamber 8. The motor current increases as the motor meets increased resistance to movement as piston 10 compresses the ground coffee in pressure chamber 8. The control 50 includes conductor 48 on which input power is supplied and directed to the motor 46. A resistor R2 is connected to the input 48 of motor 46 and establishes a signal on line 60 which is directly related to the motor current of motor 46. The signal on line 60 is directed through resistor R1 and across compositor C1 to an input 2 of an integrated circuit 62. The integrated circuit 62 is schematically illustrated in phantom lines in FIG. 9 and includes inputs/outputs 1, 2, 3, 4, 5, 6, 7, and 8. The signal applied on line 60 to input 2 of the integrated circuit 62 is a signal indicative of the motor current of motor 46 which is directly related to the resistance to movement of motor 46 and the degree of compactness of the ground coffee in pressure chamber 8. The input 3 to the integrated circuit 62 is controlled by a trimmer resistor R3 which sets a reference signal on the input 3 to the integrated circuit 62 when the reference signal set by trimmer resistor R3 on input 3 exceeds the feedback signal at input 2 on line 60 an output will be established at the output 7 of the integrated circuit to effect the energization of motor 46. The trimmer resistor R3 sets a reference signal which controls the amount of compression of the ground coffee in pressure chamber 8 and the maximum motor voltage. When the maximum motor current is exceeded, the control 50 operates the deenergize motor 46. When the reference current signal on input 3 is exceeded by the current signal fed back on line 60 an output signal is established on output 7 which is directed through resistors R4 and R5 to transistor Q1. The output at 7 of the integrated circuit causes transistor Q1 to conduct which energizes the coil of relay 70 to move relay context 72 from its full line position shown in FIG. 9 to its phantom line position shown in FIG. 9 in which it deenergizes motor 46. Relay 70 continues to hold context 72 in its phantom line position until the entire control is deenergized. A resistor R6, zenor diode Z1 and capacitor C2 are connected to the input 48 to the control 50 to filter the incoming power from the source of power to control 50.

As the motor 46 rotates cam 42 and as piston 10 compresses coffee grounds in chamber 8, the motor current increases until the ground coffee is compacted a predetermined amount at which time the current sensed by R2 on line 60 is equal to a preset value of current at terminal 3 which is related to the amount of compression of the coffee grounds in pressure chamber 8. Thus, motor 46 rotates cam 42 to compress the ground coffee in pressure chamber 8 a predetermined amount which is related to a motor parameter such as motor current. It has been found that it is desirable to compress the ground coffee to approximately 22.5 kg/cm² which has been found to equate to a motor current of 3 amps in the present embodiment. Accordingly, a reference valve of 3 amps is set at reference input 3 by trimming resistor R3 and motor 46 is deenergized when the sensed motor current equals 3 amps.

Other motor parameters such as voltage or torque could be sensed to control the amount of compression of the ground coffee in pressure chamber 8 and to deenergize motor 46 when the ground coffee is compressed a predetermined amount. The motor 46 will compress the ground coffee in pressure chamber 8 until the control senses that the motor parameter equal to a preset value. Motor parameters which are related to the amount of compression of the ground coffee in pressure chamber 8 include current, voltage and/or torque.

The stopping of motor 46 and movement of piston 10 can be at different locations depending upon the amount of ground coffee placed in pressure chamber 8. This enables the espresso maker 10 to produce espresso drinks of different sizes and requiring different amounts of ground coffee and to compact all of the different amounts of ground coffee the same amount. For example, one ounce or four ounces of ground coffee can be placed in pressure chamber 8 and compressed by the piston 10 and the motor 46 and control 50 will function to ensure that the one ounce of coffee is compacted to the same degree to which the four ounces of coffee is compacted. The amount of compactness can be controlled by setting a reference or trip value for the current at input 3 of the integrated circuit 62 which deenergizes motor 46 when the motor current reaches the reference valve. The ground coffee must be compacted prior to passing pressurized hot water through the coffee grounds to brew espresso. The amount of compression of the ground coffee is important and can be preset by utilizing a motor parameter such as current, voltage or torque to deenergize motor 46 and stop rotation of cam 42 when the ground coffee in pressure chamber 8 is compacted a predetermined amount It has been found that motor voltage and motor torque are also directly related to the amount of compression of the ground coffee in the pressure chamber. As the compression increases as cam 42 continues to rotate and piston 10 continues to move into pressure chamber 8, the motor voltage increase as does the motor torque and current Torque or voltage control could also be utilized to effect deenergization of motor 46 to control the amount of compression of the ground coffee in pressure chamber 8.

After cam 42 is rotated to its position illustrated in FIG. 4, the ground coffee in pressure chamber 8 is correctly compacted and hot pressurized water 14 is directed from the water supply 12 through conduit 20 where it is heated in boiler 18. After the water is heated in boiler 18, valve 22 is opened to pass the pressurized hot water 14 through conduit 24 and through the fluid passageway 26 disposed in piston 10. The pressurized hot water then exits from fluid passageway 26 and passes through the compacted coffee grounds in pressure chamber 8 to brew espresso and passes through the outlet 30 where it is collected in a container 32.

After espresso is brewed from the coffee grounds in pressure chamber 8, it is necessary to remove the compacted used coffee grounds from pressure chamber 8. The second or bottom opening 11 in pressure chamber 8 is normally closed by a lower piston 54 which includes an O-ring seal 56 disposed on piston head 57. When lower piston 54 is in its position illustrated in FIG. 1, the piston head 57 and O-ring 56 seal the lower opening 11 in pressure chamber 8. A latch member 52 is provided for latching the lower piston 54 in its dosed position as is illustrated in FIG. 1. When piston 54 is in its closed position and latch 52 is locked, pressurized water introduced into pressure chamber 8 will not move piston 54 to unseal opening 11.

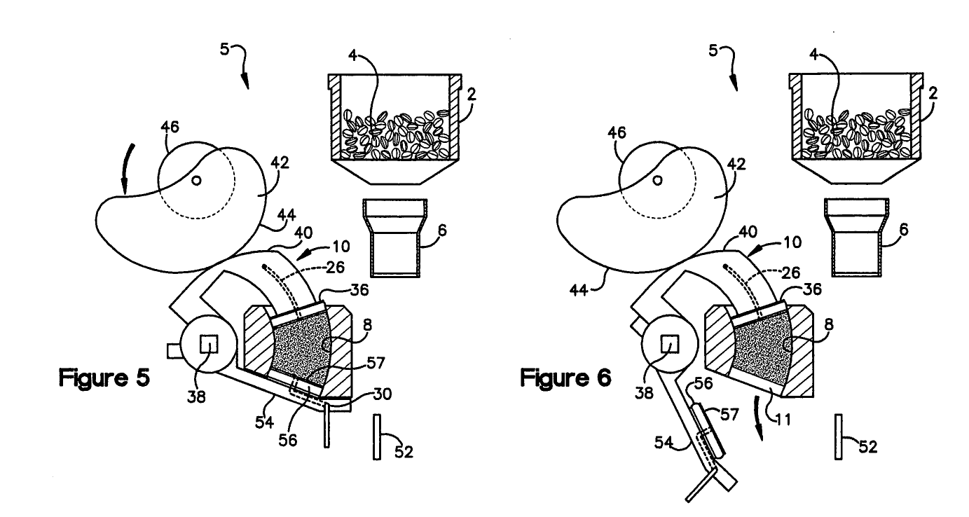

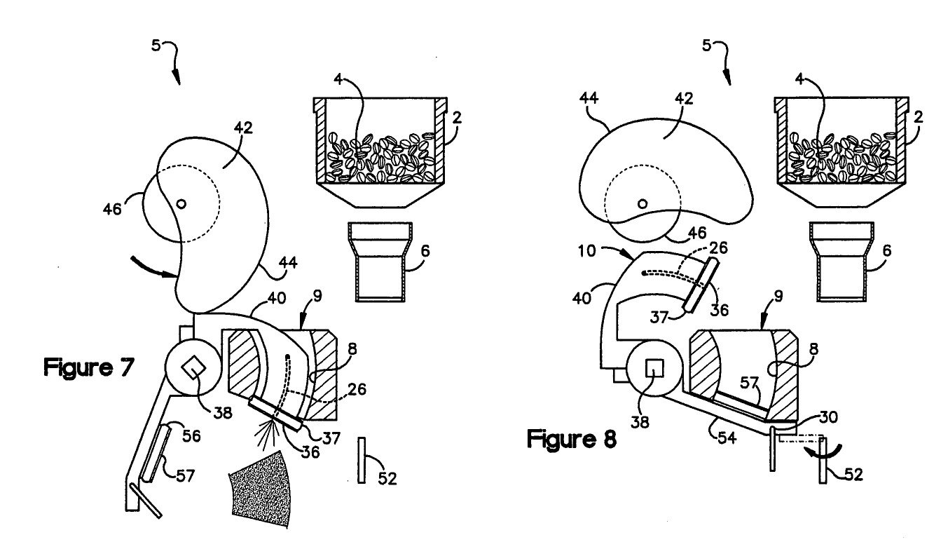

When it is desired to expel used coffee grounds from pressure chamber 8, latch member 52 is unlatched and moved to its position illustrated in FIG. 5 which allows lower piston 54 to pivot about shaft 38 in a clockwise direction from its position illustrated in FIG. 5 to its position illustrated in FIG. 6. When latch 52 is opened and piston 54 moves to its position illustrated in FIG. 6, motor 46 is energized to continue rotation of cam member 42 in a clockwise direction which continues movement of piston 10 in a clockwise direction about shaft 38 to push the compressed used ground coffee from opening 11 in the pressure chamber 8 to clean pressure chamber 8 for the next brewing cycle. As is illustrated in FIG. 7, if desired, a small blast of pressurized water may be expelled from fluid passageway 26 in piston 10 to assist in the expulsion of the used coffee grounds from pressure chamber 8 and to ensure that the coffee grounds do not stick to the piston 10.

After the ground coffee is expelled from pressure chamber 8, motor 46 continues to rotate cam 42 to its standby position illustrated in FIGS. 1 and 8 in which cam member 42 no longer biases piston 10. A suitable return spring, not illustrated, interconnects shaft 38 and piston 10 and biases piston 10 in a counterclockwise direction about shaft 38 to its standby position illustrated in FIGS. 1 and 8. Piston 10 is operatively connected with lower piston 54 so that when the return spring bias piston 10 to its standby position, movement of piston 10 to its standby position also effects movement of piston 54 in a counter clockwise direction about shaft 38 to return piston 54 to its position in which piston 54 closes the bottom of pressure chamber 8. After lower piston is moved to its position in which it closes the bottom opening 11 of the pressure chamber 8, latch member 52 is moved to its locked or latched position shown in phantom lines in FIG. 8 to lock piston 54 in its position in which it seals the lower opening 11 of the pressure chamber 8. A solenoid, not illustrated, can be used to move latch 52 between its latched and unlatched positions. The espresso making apparatus is now in condition to brew another espresso beverage.

It should be appreciated that control 50 can also control pump 16, energization of boiler 18, valve 22 and movement of coffee grinder 6 to grind and deposit ground coffee in pressure chamber 8. In addition, the control can be connected to a credit selection mechanism, not illustrated, which can provide for payment and selection of the espresso drink to be brewed. Because a cam 42 member is used to position piston 10 various sized espresso drinks can be brewed as opposed to prior art automatic espresso brewers which only brew a single sized espresso drink.

From the foregoing, it should be appreciated that a new and improved espresso making apparatus 5 and method of brewing espresso has been disclosed. The espresso maker 10 includes a supply 12 of water 14 which is pressurized by a pump 16 and heated by a boiler 18. A pressure chamber 8 is adapted to receive a predetermined amount of ground coffee from a coffee hopper 4 and coffee grinder 6. A piston 10 is movable within the pressure chamber 8 to compress the ground coffee and a motor 46 rotates cam 42 which engages with a cam follower 40 disposed on the piston 10 to move piston 10 to compress the ground coffee located within the pressure chamber 8. A control 50 senses a parameter of the motor 46 such as current or voltage when the motor 46 rotates cam 42 which moves the piston 10 to compress the ground coffee. The control 50 deenergizes the motor 46 to stop movement of the piston 10 when the ground coffee in the pressure chamber 8 is compressed a predetermined amount which is related to the motor parameter. A conduit 24 is provided for directing the supply of pressurized hot water through the compressed ground coffee in the pressure chamber 8 to brew espresso and an outlet 30 is provided from the pressure chamber 8 for directing the brewed espresso to a use location such as a cup 32. The method of brewing espresso using the disclosed apparatus includes the steps of providing a predetermined amount of ground coffee in the pressure chamber 8, energizing the motor 46, moving the piston 10 within the pressure chamber 8 in response to energization of the motor 46 to compact the ground coffee, sensing a motor parameter such as current or voltage and deenergizing the motor 46 to stop movement of the piston 8 when the sensed motor parameter is equal to a predetermined value and the ground coffee is compacted a predetermined amount.

1. An espresso making apparatus comprising a supply of pressurized hot water, a pressure chamber adapted to receive a predetermined amount of ground coffee therein, a piston movable within said pressure chamber to compress ground coffee located within said pressure chamber, a cam, a motor for rotating said cam, a cam follower engageable with said cam and being operatively connected to said piston for moving said piston to compress ground coffee located within said pressure chamber in response to rotation of said cam, a sensor for sensing a parameter of said motor when said motor rotates said cam to compress ground coffee located within said pressure chamber, a control for deenergizing said motor to stop movement of said cam when the ground coffee in said pressure chamber is compressed a predetermined amount and the sensed motor parameter is equal to a predetermined value, a fluid passageway for directing said supply of pressurized hot water through the compressed ground coffee in said pressure chamber to brew espresso coffee, and an outlet from said pressure chamber for directing the brewed espresso coffee to a use location.

2. An espresso making apparatus as defined in claim 1, wherein said sensor is a current sensor and the sensed motor parameter is motor current.

3. An espresso making apparatus as defined in claim 1, wherein said sensor is a voltage sensor and the sensed motor parameter is motor voltage.

4. An espresso making apparatus as defined in claim 1, wherein said sensed motor parameter is motor torque.

5. An espresso making apparatus as defined in claim 1, wherein said fluid passageway for directing said supply of pressurized hot water through the compressed ground coffee in said pressure chamber is at least in part located in said piston.

6. An espresso making apparatus as defined in claim 1, wherein said pressure chamber includes a first opening for receiving said piston, and a second opening for discharging compressed ground coffee from said pressure chamber after espresso has been brewed from said compressed ground coffee.

7. An espresso making apparatus as defined in claim 6, further including a second piston having a first closed position for sealing said second opening, said second piston being movable to a second open position to discharge compressed ground coffee from said pressure chamber after espresso has been brewed from said compressed ground coffee and a latch member for latching said second piston in said first closed position.

8. An espresso making apparatus as defined in claim 7, wherein said latch member has an unlatched position in which said second piston is unlatched to enable said second piston to move to said second open position to provide for the discharge of the compressed ground coffee from said second opening in said pressure chamber after espresso has been brewed from said compressed ground coffee.

9. An espresso making apparatus as defined in claim 8, wherein said motor is energizable to rotate said cam to move said piston toward said second opening to enable said piston to push said compressed ground coffee from said pressure chamber through said second opening after espresso has been brewed from said compressed ground coffee.

10. An espresso making apparatus as defined in claim 1, wherein said pressure chamber is adapted to receive different predetermined amounts of ground coffee therein for brewing different espresso drinks each of which may require a different predetermined amount of ground coffee and said control for deenergizing said motor deenergizes said motor and stops movement of said cam when said ground coffee in said pressure chamber is compressed a predetermined amount irrespective of the amount of ground coffee in said pressure chamber.

11. An espresso making apparatus as defined in claim 10, wherein said pressure chamber includes a first opening for receiving said piston, and a second opening for discharging compressed ground coffee from said pressure chamber after espresso has been brewed from said compressed ground coffee.

12. An espresso making apparatus as defined in claim 11, further including a second piston having a first closed position for sealing said second opening, said second piston being movable to a second open position to discharge compressed ground coffee from said pressure chamber after espresso has been brewed from said compressed ground coffee and a latch member for latching said second piston in said first dosed position in which said second piston seals said second opening.

13. An espresso making apparatus as defined in claim 12, wherein said fluid passageway for directing said supply of pressurized hot water through the compressed ground coffee in said pressure chamber is at least in part located in said piston.

14. An espresso making apparatus as defined in claim 13, wherein pressurized hot water is directed through said fluid passageway in said piston when said piston pushes said compressed ground coffee from said pressure chamber through said second opening to ensure that the compressed ground coffee does not stick to said piston.

15. An espresso making apparatus comprising a supply of pressurized hot water, a pressure chamber adapted to receive ground coffee therein, a piston movable within said pressure chamber to compress the ground coffee located within said pressure chamber, a motor for moving said piston to compress the ground coffee located within said pressure chamber, a sensor for sensing a parameter of said motor when said motor moves said piston to compress the ground coffee within said pressure chamber, a control responsive to said sensor for deenergizing said motor to stop movement of said piston when the ground coffee in said pressure chamber is compressed a predetermined amount and said sensor indicates the sensed motor parameter is equal to a predetermined value, a fluid passageway for directing said supply of pressurized hot water through the compressed ground coffee in said pressure chamber to brew espresso and an outlet from said pressure chamber for directing the brewed espresso to a use location.

16. An espresso making apparatus as defined in claim 15, wherein sensor is a current sensor and said sensed motor parameter is motor current.

17. An espresso making apparatus as defined in claim 15, wherein sensor is a voltage sensor and said sensed motor parameter is motor voltage.

18. An espresso making apparatus as defined in claim 15, wherein sensor is a torque sensor and said sensed motor parameter is motor torque.

19. An espresso making apparatus as defined in claim 15, wherein said fluid passageway for directing said supply of pressurized hot water through the compressed ground coffee in said pressure chamber is at least in part located in said piston.

20. An espresso making apparatus as defined in claim 15, wherein said pressure chamber includes a first opening for receiving said piston and a second opening for discharging compressed ground coffee from said pressure chamber after espresso has been brewed from said compressed ground coffee.

21. An espresso making apparatus as defined in claim 20, further including a second piston having a first closed position for sealing said second opening, said second piston being movable to a second open position to provide for the discharge of compressed ground coffee from said pressure chamber after espresso has been brewed from said compressed ground coffee and a latch member for latching said second piston in said first closed position in which said second piston seals said second opening.

22. An espresso making apparatus as defined in claim 21, wherein said latch member has an unlatched position which unlatches said second piston to enable said second piston to move to said second open position to provide for the discharge of the compressed ground coffee from said second opening in said pressure chamber after espresso has been brewed from said compressed ground coffee.

23. An espresso making apparatus as defined in claim 15, wherein said motor is energizable to move said piston toward said second opening to enable said piston to push said compressed ground coffee from said pressure chamber through said second opening when said latch member is in said unlatched position after espresso has been brewed from said compressed ground coffee.

24. An espresso making apparatus as defined in claim 15, further including a cam member connected to said motor and rotatable in response to energization of said motor, said cam member being operatively associated with said piston for moving said piston in response to rotation of said cam member.

25. A method of brewing espresso from a supply of pressurized hot water and ground coffee which has been compacted a predetermined amount in a pressure chamber by a piston which is moved by a motor to compact the ground coffee in the pressure chamber including the steps of:
providing ground coffee in said pressure chamber;
energizing the motor;
moving the piston within said pressure chamber to compact the ground coffee in response to energization of the motor;
sensing a motor parameter of said motor while said motor moves said piston and compacts the ground coffee in said pressure chamber; and
deenergizing the motor to stop movement of said piston when the sensed motor parameter is equal to a predetermined value and said ground coffee is compacted a predetermined amount in said pressure chamber.

26. A method of brewing espresso as defined in claim 25, further including the steps of:
directing a predetermined amount of pressurized hot water through the compacted ground coffee in said pressure chamber to brew espresso; and
energizing the motor to further move the piston within said pressure chamber to expel the compacted ground coffee from which espresso has been brewed from the pressure chamber.

27. A method of brewing espresso as defined in claim 26, further including the step of directing pressurized hot water to the pressure chamber to assist in expelling the compacted ground coffee from which espresso has been brewed from the pressure chamber.

28. A method of brewing espresso as defined in claim 25, wherein said step of sensing a motor parameter includes the step of sensing motor current and said step of deenergizing the motor to stop rotation of the cam and movement of the piston is performed when the motor current is equal to a preselected motor current.

29. A method of brewing espresso as defined in claim 25, wherein said step of sensing a motor parameter includes the step of sensing motor voltage and said step of deenergizing the motor to stop rotation of the cam and movement of the piston is performed when the motor voltage is equal to a preselected motor voltage.

30. A method of brewing espresso as defined in claim 25, wherein said step of sensing a motor parameter includes the step of sensing motor torque and said step of deenergizing the motor to stop rotation of the cam and movement of the piston is performed when the motor torque is equal to a preselected motor torque.
